(19) United States
(12) Patent Application Publication
(10) Pub. No.: US 2017/0118291 A1
(43) Pub. Date: Apr. 27, 2017

(54) INFORMATION PROCESSING SYSTEM APPLIED IN A VEHICLE SYSTEM

(71) Applicant: LEAUTO INTELLIGENT TECHNOLOGY (BEIJING) CO.LTD, Beijing (CN)

(72) Inventor: Peng TIAN, Beijing (CN)

(21) Appl. No.: 14/971,835

(22) Filed: Dec. 16, 2015

(30) Foreign Application Priority Data
Oct. 21, 2015 (CN) 201510689338.7

(51) Int. Cl. H04L 29/08; H04W 4/00; H04W 4/02; H04W 76/02

(52) U.S. Cl. CPC H04L 67/12; H04W 76/02; H04W 4/005; H04W 4/02

(57) ABSTRACT

The disclosure provides a information processing system applied in a vehicle system, which includes a processing and a plurality of detecting devices establishing the wireless connection with the processing device; the plurality of detecting devices is respectively disposed on different positions in the vehicle and used to detect a vehicle state information; the processing device and an electronic device establish a wireless connection to transmit the vehicle state information of the plurality of detecting devices to the electronic device. Therefore, the disclosure enriches the function of the vehicle system, and increases the utilization of vehicle system in the vehicle.

### CROSS REFERENCE TO RELATED APPLICATION

This application claims priority under 35 U.S.C. §119(a) to Patent Application No(s). 201510689338.7, filed in China on Oct. 21, 2015, the entire contents of which are hereby incorporated by reference.

### FIELD OF TECHNOLOGY

The disclosure is related to vehicle technology field, and more particular to an information processing system.

### BACKGROUND

With the continuous development and progress of science and technology, the vehicle system applied in the car, easy for the user to travel, capable of bring the convenient operation to the user and bringing more user experience begins to appear in the vehicle.

Currently, most of the vehicle system mainly provides vehicle navigation providing the satellite positioning and the electronic map function. However, with the increasing of user demands, including the demands of the safety for the vehicle driver, the comfort and vehicle driving state, the existing vehicle system cannot meet the user demands and the function is relatively simple.

### SUMMARY

The disclosure provides an information processing system applied in a vehicle system, thereby solving the technique problem that the function in the vehicle system of the prior art is relatively simple.

The disclosure provides an information processing system applied in a vehicle system, which includes:

a processing device and a plurality of detecting devices which establish a wireless connection with the processing device;

the plurality of detecting devices respectively disposed on different positions in a vehicle, for detecting a plurality of vehicle state information;

the processing device establishes a wireless connection with an electronic device, for transmitting the vehicle state information detected by the plurality of detecting devices to the electronic device.

The disclosure provides an apparatus for displaying a location information. When the user uses the position service of the terminal to query the target position, the terminal may obtain the target position information and the user position information of the user at the same time, calculate the deviation information between the current position of the user and the target position and then adjust the displayed position of the user position icon in the location interface according to the deviation information. Therefore, the user may intuitively know the relative direction between the location of the user and the target position, thereby increasing efficiency of obtaining the location information for the user effectively.

In the disclosure, the information processing system applied in the vehicle system includes the processing device and the plurality of detecting devices established the wireless connection with the processing device. The processing device obtains the vehicle state information detected by the detecting devices and transmits the vehicle state information to the electronic device established the wireless connection with the processing device, so as to trigger the electronic device to output for prompting the user. Therefore, the disclosure achieves the interaction with the electronic device and performs the detections for the vehicle to prompt the vehicle state to the user, thereby providing the user experience, enriching the function of the vehicle system, and increasing the utilization of vehicle system in the vehicle.

### BRIEF DESCRIPTION OF THE DRAWING(S)

In order to more clearly illustrate the technical schemes of the prior art or the embodiments of the disclosure, the accompanying drawings for illustrating the prior art or the embodiments of the disclosure are briefly described as below. It is apparently that the drawings described below are merely some embodiments of the disclosure, and those skilled in the art may derive other drawings according the drawings described below without creative endeavor. In the drawings:

FIG. 1 is a structure schematic view of an information processing system applied in a vehicle system according to one embodiment of the disclosure;

FIG. 2 is a structure schematic view of an information processing system applied in a vehicle system according to one embodiment of the disclosure;

FIG. 3 is a structure schematic view of an information processing system applied in a vehicle system according to one embodiment of the disclosure;

FIG. 4 is a structure schematic view of an information processing system applied in a vehicle system according to one embodiment of the disclosure;

FIG. 5 is a structure schematic view of an information processing system applied in a vehicle system according to one embodiment of the disclosure;

FIG. 6 is a structure schematic view of a information processing system applied in a vehicle system according to one embodiment of the disclosure; and

FIG. 7 is a structure schematic view of an information processing system applied in a vehicle system according to one embodiment of the disclosure.

### DESCRIPTION OF THE EMBODIMENTS

For the purpose, technical solution, and advantage of the disclosure becoming clearer, the specific embodiments of the disclosure combined with the accompanying drawings are described clearly and completely as follows. Obviously, the described embodiments are only part of the embodiments of the disclosure rather than all embodiments. Based on the embodiments of the disclosure all other embodiments obtained by those having ordinary skills in this field without creative work are within the scope of protection of the disclosure.

The technique aspect of the disclosure is mainly applied in the vehicle of the car. In the disclosure, according to the information processing system applied in the vehicle system, it may achieve the detection of the vehicle, and the detected vehicle state information is transmitted to the electronic device, so as to achieve the interaction with the electronic device and perform the different detections for the vehicle to ensure the safety of the driver, thereby providing a better vehicle experience, enriching the function of the vehicle system, and increasing the utilization of vehicle system in the vehicle.

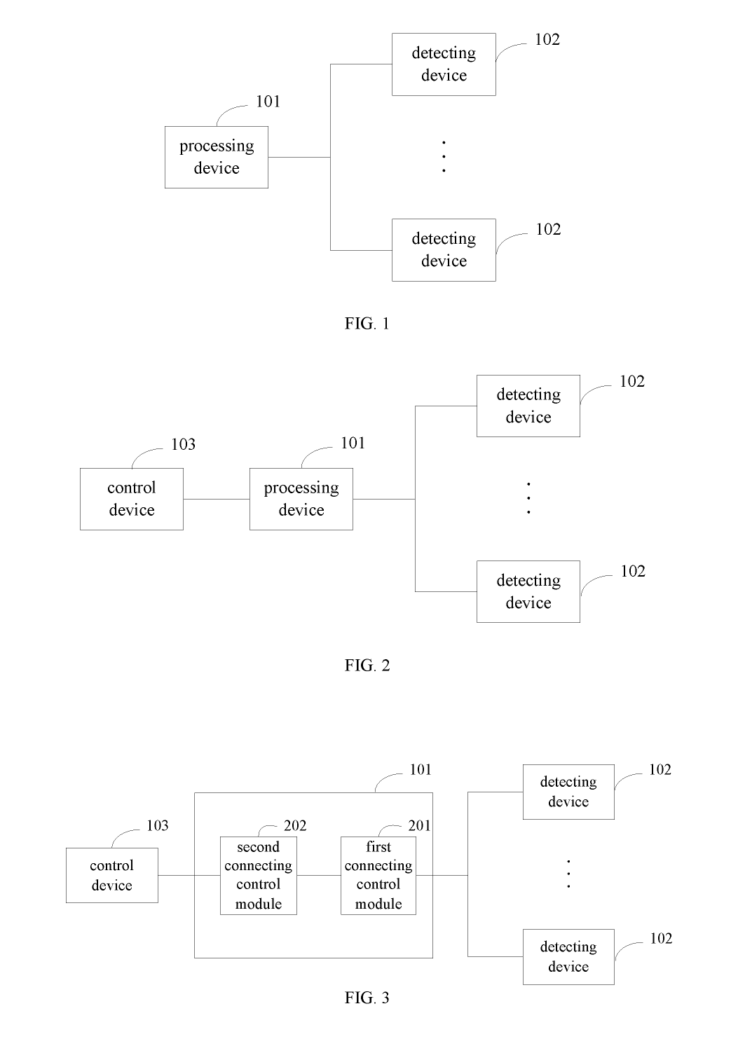

FIG. 1 is a structure schematic view of an information processing system applied in a vehicle system according to one embodiment of the disclosure. The system includes a processing device 101 and a plurality of detecting devices 102 which establish a wireless connection with the processing device 101.

The plurality of detecting devices 102 is respectively disposed on different positions in a vehicle for detecting a plurality of vehicle state information.

The processing device 101 is capable of establishing a wireless connection with an electronic device and transmits the vehicle state information detected by the plurality of detecting devices 102 to the electronic device.

Wherein, the plurality of detecting devices is used for detecting different types of vehicle state information. The vehicle state information may at least include a temperature inside and outside the vehicle, a humidity inside the vehicle, a tire pressure, a vehicle motion parameters, such as a speed, an acceleration, an angular velocity, a brightness inside the vehicle and an air quality inside the vehicle.

Therefore, the plurality of detecting devices may at least include a pressure sensor, a temperature sensor, a vibration sensor, a three-axis sensor, a humidity sensor, a brightness sensor, an air sensor and etc.

In the embodiment of the disclosure, the information processing is applied in the vehicle system. As a configuration of the vehicle, it may establish a wireless connection with the electronic device through the information processing system and transmit the vehicle state information of the plurality of detecting devices to the electronic device, and the electronic device outputs the vehicle information, thereby achieving an interaction with the electronic device, and thus achieving a detection of each direction for the vehicle. Further, it ensures a safety of the driver, provides a better vehicle experience, increases a functionality of the vehicle system, and an efficiency of the vehicle system in the vehicle.

Of course, the processing device may also generate a processing command according to the vehicle state information detected by the detecting devices and execute a corresponding processing operation in response to the processing command. For example, when determining the temperature inside the vehicle is higher according to the vehicle state information of the detecting devices, the processing device generates a power off command and may automatically power off in response to the power-off command.

Specifically, the wireless connection established by the processing device and the plurality of detecting devices may be a Zigbee connection. The Zigbee technique is a short-range, low-power wireless communication technique and it may be embedded in a variety of devices, so as to easily expand. The processing device may establish a connection with up to 65,535 nodes; therefore, it may easily expand the detecting devices.

As another embodiment, the processing device may includes a first connecting control module and a second connecting control module connected each other, and the processing device specifically establishes a wireless connection with the plurality of detecting devices through the first connecting control module.

The processing device specifically establishes a wireless connection with the electronic device through the second connecting control module.

The first connecting control module transmits the vehicle state information of the plurality of detecting devices to the second connecting control module and then the second connecting control module transmits the vehicle state information to the electronic device.

As a still another embodiment, as shown in FIG. 2, it is different from the embodiment as shown in FIG. 1 that, the information processing system further includes a control device establishing a wireless connection with the processing device 101.

The processing device 101 is further used to receive a control command of the control device 103, and transmit the control command to the electronic device to trigger the electronic device in response to the control command.

Additionally, the processing device 101 is further used to receive a processing command of the control device 103, and execute a corresponding processing operation in response to the processing command.

Further, in order to facilitate operation for the user, the control device may be configured in a steering wheel inside the vehicle.

A plurality of control buttons may be configured in the control device, and the control command of the control device may be generated by the user operating the control button to trigger.

In the control device, each of the control buttons may achieve the corresponding operation of the processing device and electronic device for the user.

For example, when the processing device may receive a transmitting control command of the control device, the processing device sends the transmitting control command to the electronic device, and the electronic device requests to obtain the vehicle state information detected by the plurality of detecting devices.

Of course, the control device further generates a processing command for the processing device, so as to control the processing device to perform the corresponding operation, for example, when the processing device may receive the transmitting process command of the control device, the vehicle state information detected by the plurality of detecting device is transmitted to the electronic device.

Additionally, the established connection of the control device and the processing device may also be established by operating the corresponding control button in the control device to trigger.

The control button in the control device may be a physical key or a touch key, etc.

As a possible implement manner, the control device may include a controller, such as a micro control unit (MCU), and a control button connected to the controller, wherein the control button may be disposed on a touch panel connected to the controller.

The connection of the control device and the processing device may be a connection of the control unit and the processing device, and the control unit generates a corresponding command according to a triggering operation of the control button, and the corresponding command is then transmitted to the processing unit. When the control button is the touch key, the operations corresponding to the different generated commands may include a control manner, such as one click, double click, press for a longer time, etc.

The controller in the control device may be a bluetooth processing chip for establishing a bluetooth connection with the processing unit and may transmit the control command corresponding to the control button to the processing device.

In the embodiment, by displaying the control device, it may easily implement an interaction between the processing device and the electronic device, without operating the processing device or the electronic device, thereby achieving a control for the processing device or the electronic device to facilitate the control operation.

As a still another embodiment, as shown in FIG. 3, it is different from the embodiment as shown in FIG. 2 that, in the information processing system, the processing device 101 may include a first connecting control module 201 and a second connecting control module 202 connected each other.

The processing device 101 is connected to the plurality of detecting device 102 through the first connecting control module 201.

The processing device 101 is connected to the electronic device and the control device 103 through the second connecting control module 202.

The first connecting control module and the second connecting control module may be a processor or a MCU, etc.

The first connecting control module may establish a Zigbee connection with the plurality of detecting devices, and the first connecting control module may be a Zigbee Integrated chip, such as CC2530, or a controller or a processor with the integrated Zigbee function, etc.

The second connecting control module may establish a bluetooth connection with the electronic device and the control device, and the second connecting control module may be a bluetooth processing chip, such as CSR8670, or a controller or a processor with the integrated bluetooth function, etc.

The first connecting control module transmits the vehicle state information of the plurality of detecting device to the electronic device. Specifically, it may be achieved based on a bluetooth SPP protocol.

In the embodiment, the electronic device and the control device establish the bluetooth connection with the processing device, so as to easily achieve an interaction with the electronic device, and the processing device establishes the Zigbee connection with the plurality of detecting devices, so as to easily extend the nodes, such that the applicability of the processing device is stronger.

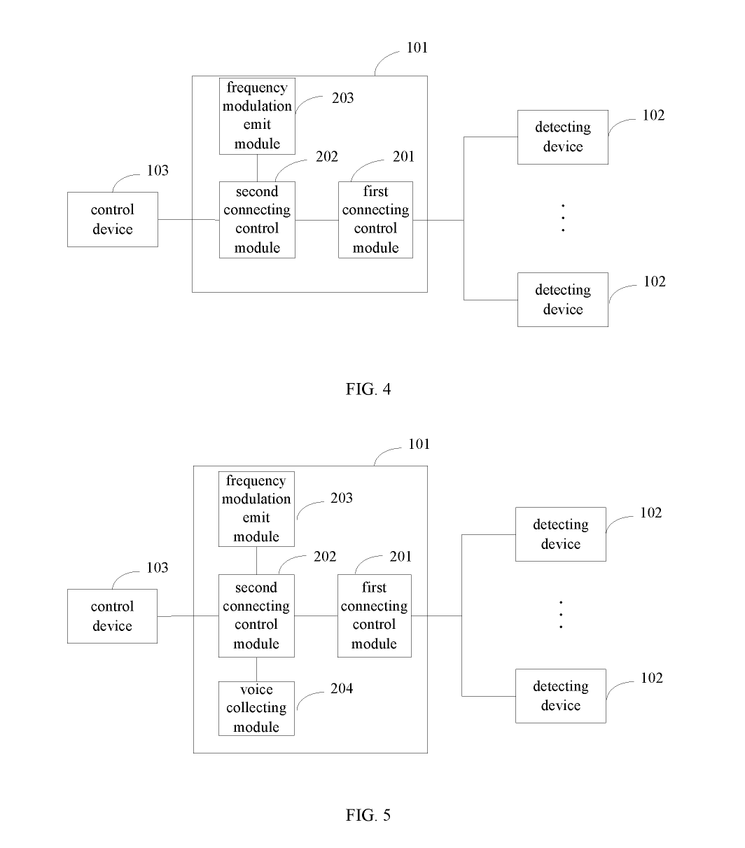

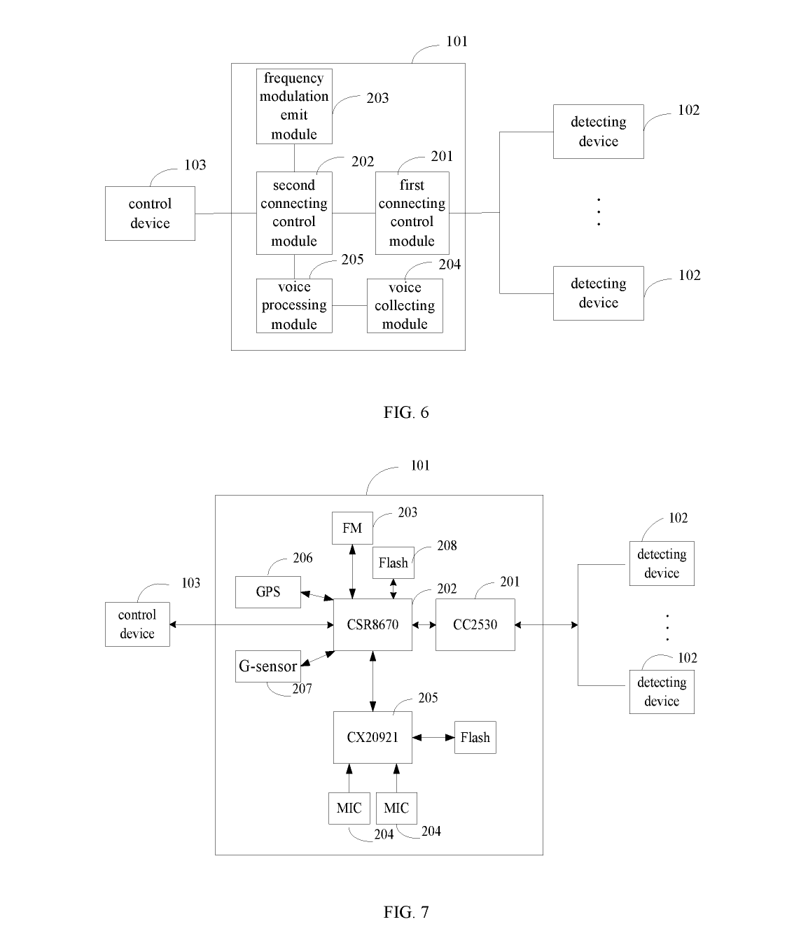

As a still another embodiment, as shown in FIG. 4, it is different from the embodiment as shown in FIG. 3 that, in the information processing system, the processing device 101 further include a frequency modulation transmitting module 203 connected to the second connecting control module 202.

The second connecting control module 202 further obtains am audio data transmitted by the electronic device; the frequency modulation transmitting module 203 transmits the audio data transmitted by the electronic device in a predetermined frequency band, such that a frequency modulation play device in the vehicle system receives and plays at the predetermined frequency band.

The frequency modulation transmitting module 203 responses to the trigger command of the second connecting control module 202 to transmit the audio data in the predetermined frequency band, such that the frequency modulation play device in the vehicle receives and plays at the predetermined frequency band.

The predetermined frequency band may be previously stored in the processing device, and may also be selected by the electronic device to transmit to the processing device.

In the embodiment, the audio data of the electronic device is played in the frequency modulation play device in the vehicle through the frequency modulation transmitting module, such that the user may easily listen to the audio data in electronic equipment and fully use the electronic device, thereby increasing the utilization of the information processing system in the vehicle and achieving the diversity of the interaction with the electronic device.

The frequency modulation play device may be a frequency modulation radio. Currently, the frequency modulation play device is disposed in the vehicle of the for listening to the frequency modulation broadcast, thereby using the frequency modulation play device to achieve the playing of the audio data in electronic device.

The audio data of the electronic device may be controlled by the control command of the control device, for example, when the audio data is the data outputted by the music player of the electronic device, the control command may includes previous song/next song, volume+/volume−, confirm/return. The different commands may be achieved by triggering the control buttons in the control device or may be achieved by performing the different trigger operation of the control button of the control device when the control buttons are the touch button. After the processing receives the control command and transmits the control command to the electronic device, and then the electronic device responses the control command, such that the electronic device may be achieved to switch the audio data, adjust the volume, pause or restart the playing of the audio data.

As a still another embodiment, as shown in FIG. 5, it is different from the embodiment as shown in FIG. 4 that, in the information processing system, the processing device 101 further includes a voice collecting module 204 connected to the second connecting control module 202.

The voice collecting module 204 is used for collecting an environment sound.

The second connecting control module 202 further transmits the environment sound collected by the voice collecting module to the electronic device.

After receiving the environment sound, the electronic device may perform a speech recognition for the environment sound to recognition the speech command and perform a corresponding operation in response to the speech command, such as turn on some application in the electronic device, or initiate a call, etc.

The voice collecting module may be a microphone (MIC) array.

Since the noise may exist in the environment sound, the second connecting control module may further perform a noise reduction process for the environment sound collected by the voice collecting module and then transmit the environment sound to the electronic device.

Of course, the noise reduction process performed for the environment sound may be achieved by the voice processing module. As shown in FIG. 0.6, it is different from the embodiment as shown in FIG. 5 that, the processing unit may further include voice collecting module 204 and a voice processing module 205 connected to the second connecting control module 202.

The voice processing module 205 is used for performing a noise reduction process for the environment sound collected by the voice collecting module 204.

The second connecting control device 202 transmits the environment sound collected by the voice collecting module to the electronic device, wherein the environment sound is performed by the noise reduction process through the voice processing module 205.

In the practical application, the voice processing module may be, for example, a speech processing chip, such as a voice processing chip with model CX20921.

In the practical application, the audio data obtained by the second connecting control module may be a speech communication data, wherein the audio data is transmitted by the electronic device.

The second connecting control module may also be used for receiving a call request of the electronic device; when receiving an answer command, the electronic device is controlled to establish a voice communication channel.

The operation for second connecting control module obtains the audio data transmitted by the electronic device is as following:

obtains the audio data sent by the electronic device and received by the speech communication channel, i.e. the speech communication data.

Therefore, the speech communication data is played in the frequency modulation play device through the processing device, thereby achieving the frequency modulation play device in the vehicle system to listen to the speech communication data.

The answer command may be triggered by the user, and the processing device may be configured with different control buttons. The user may trigger the different control buttons to trigger the processing device for generating different control commands, wherein the answer command is a control command is generated by triggering the call control button.

Of course, the answer command may be a control command generated by operating the control device 103.

The connection established by the second connecting control module 202 and the electronic device is a bluetooth connection, thereby achieving a call control for the electronic device based on a hands-free profile (HFP) protocol. The HFP protocol defines the bluetooth device to control the call, such as the function of answer, hang up, reject, speech dialing, etc.

In the embodiment, the processing device may receive the call request of the electronic device and control the electronic device to establish the speech communication channel.

Of course, when receiving the hang up command, the electronic device may be controlled to end the call request.

The control command of answer, hang up, reject, end, etc. is generated by operating the control button in the control device and is transmitted to the electronic device through the processing device, and then the electronic device responses the control command.

In the speech communication scene, the second connecting control module 202 obtains the audio data transmitted by the electronic device and received by the speech communication channel. In order to achieve the voice communication between the two users, the voice collecting module 204 collects the environment sound, and the environment sound includes voice of the user; the environment sound is transmitted to the electronic device through the second connecting control module 202, and the electronic device is triggered to transmit the environment sound to the speech communication channel, thereby achieving the speech communication. The speech communication data received by the electronic device may be listened to by the information processing system and the environment sound may also be transmitted to the electronic device, so as to trigger the electronic device to transmit the environment sound through the voice communication channel, thereby achieving the voice communication.

The environment sound is mainly a voice of the user. Since the environment sound includes not only the voice of the user, it is also possible to perform the noise reduction process for the environmental voice. Since a maximum interference caused by the voice of the user is the voice played by the frequency modulation play device, it is capable eliminating the voice in the environment sound played by the frequency modulation play device, so as to obtain the voice of the user with low noise.

In the speech communication scenario, when the second connecting control module receives the call request of the electronic device, if the electronic device sets the call play, and the call play voice may also be sent through the frequency modulation transmitting module in the predetermined frequency band, thereby achieving the call broadcast in the frequency modulation transmitting module. The call broadcast includes the audio data of the call number and contact name, etc.

Of course, by the frequency modulation transmitting module and when the connection may also be established by the second connecting control module and the electronic device, the frequency modulation transmitting module is triggered to transmit a first predetermined audio data in the predetermined frequency band, and the first predetermined audio data may be “device connection successful” and may be played by the frequency modulation play device to prompt the user.

When disconnecting with the electronic device, the frequency modulation transmitting module may be triggered to transmit a second predetermined audio data in the predetermined frequency band, and the first predetermined audio data may be “device has been disconnected” and may be played by the frequency modulation play device to prompt the user.

When the second connecting control module receives the call request or the short message request, the frequency modulation transmitting module may also be triggered to emit a third predetermined audio data in the predetermined frequency band, and the third predetermined audio data may be “new call or new message.”

As a still another embodiment, in the information processing system, the processing device further includes a global positioning system module (GPS) connected to the second connecting control module, so as to achieve the navigation and the electronic device function and collect the information of the vehicle location to achieve the positioning and tracking functions. It is the same as the prior art, thus the description is omitted.

The processing device further includes an acceleration sensor connected to the second connecting control module, the second connecting control module may in real time obtain the current state of the vehicle, such as the state of the sudden acceleration, the sudden deceleration, the sharp turns and the collision, etc.

As a still another embodiment, in the information processing system, the processing device further includes a storage module, for at least storing the vehicle state information detected by the plurality of detecting devices; further storing the parameter information collected by the GPS module and the acceleration sensor.

The storage module may be a flash.

After the second connecting control device is connected to the electronic device, the second connecting control device further synchronously transmits the vehicle state information stored by the storage device to the electronic device. Therefore, the electronic device outputs a prompt information according to the vehicle state information, so as to prompt the current state of the vehicle to the user.

As a still another embodiment, in the information processing system, the processing device further includes a power management module connected to each module, so as to supply a power to each module.

The power management module includes a power interface for connecting a power supply device in the vehicle. The power interface may be a micro universal serial bus (USB) interface.

The micro USB defines as the following table:

| pin | name | color of line | description |
|---|---|---|---|
| 1 | VBUS | Red | power + 5 V |
| 2 | D− | White | data line minus |
| 3 | D+ | Green | data line plus |
| 4 | ID | none | wake-up signal |
| 5 | GND | Black | ground line |

Additionally, the processing device further includes a power supply module connected to the power management module, and the power supply module includes a USB interface, wherein the USB interface may connect to the electronic device and provide a power voltage to the electronic device and charge the electronic device.

It may be seen from the above description that the processing device may also generate the processing command according to the vehicle state information detected by the detecting devices, and perform the corresponding processing operation in response to the processing command.

Therefore, as a possible implement manner, the second connecting control module may determines the temperature inside the vehicle according to the vehicle state information detected by the temperature sensor in the plurality of detecting devices. When the determined temperature is higher, the second connecting control module may trigger the power management module to stop supplying the power, and disconnect the connection with the power supply device in vehicle.

As a still another embodiment, after establishing the wireless connection with the electronic device, the second connecting control module may further output the prompt information or transmit the prompt information to the electronic device and then the electronic device outputs the prompt information, so as to prompt the electronic device connected successfully to the user.

As a possible implement manner, the processing device may also be provided with a plurality of indicators connected to the second connecting control module, and the different device states may indicated by lighting on or off the different indicator; or only one indicator, which indicates the different states through the different colors. After establishing the wireless connection with the electronic device, the indicator indicating the connection state may be lighted on or the indicator may be changed to green, so as to indicate the device connection successful; if the indicator indicating the connection state changes to red, it may indicate the connection failure.

When the second connecting control module receives the call request of the electronic device, the call indicator may be lighted on or the indicator may be changed to green, so as to indicate the call request of the electronic device to the user.

Of course, referring to the above description, the prompt information may also be a predetermined audio data, which may be emitted by the frequency modulation transmitting module and played by the frequency modulation play device, so as to output the speech prompting.

As another possible implement manner, the processing device may send the prompt information to the control device, and the control device may be provided with the indicators. According to prompt information, the indicators may be controlled to display the different colors or the different indicators may be controlled to light on or flash, so as to prompt the user.

In the embodiment of the disclosure, the connecting control module in the processing device may support different operating systems, such as Android and IOS system. The processing device may be provided with an over-the-air technology (OTA) interface, so as to upgrade the operating system of the connecting control module.

When the first connecting control module is the bluetooth processing module, it may support a variety of bluetooth protocols, such as HFP, advanced audio distribution profile (A2DP), audio/video remote control profile (AVRCP), serial port profile (SPP), so as to achieve the transmission and the control of the data through the bluetooth.

As shown in FIG. 7, FIG. 7 is a structure schematic view of an information processing system applied in a vehicle system according to a still another embodiment of the disclosure. FIG. 7 is one structure view of the information processing system in the practical application.

The information processing system includes a processing device 101, a plurality of detecting devices 102 and a control device.

The processing device 101 includes a first connecting control module 201, such as a Zigbee integrated chip CC2530; the Zigbee integrated chip and a plurality of detecting devices establish a Zigbee connection, and the plurality of detecting devices include different sensors;

a second connecting control module 202 connected to the connecting control module 201, such as a bluetooth processing chip CSR8670; the control device 103 and the electronic device establish a bluetooth connection with the bluetooth processing chip

a frequency modulation transmitting module 203 connected to the bluetooth processing chip, a voice processing module 205 such as a speech processing chip CX20921 and a voice collecting module 204 formed of the MIC array.

The processing device 101 further includes a GPS module 206 and a gravity sensor (G-sensor), etc.; of course, it may also include other sensors.

The processing device 101 further includes a storage module 208, such as a flash.

In the embodiment, the function of each component in the information processing system may refer to the description in the above embodiment, thus the description is omitted.

The plurality of detecting devices may be determined according to the sensors are not disposed in the processing device.

Several possible sensors are listed as the following:

a thermal sensor that may make the control keys in the processing device to add the touch key functions, so as to achieve the function, such as the songs switched by sliding front and back and the volume controlled by sliding up and down/rotating left and right;

a pressure sensors that may detect the tire pressure;

a temperature sensor that may detect the temperature inside and outside the vehicle;

a vibration sensor that may detect whether the vehicle is normal vibration;

a three-axis sensor that may detect the acceleration, the angle of the vehicle;

a humidity sensor that may detect an environment humidity;

a brightness sensor that may automatically adjust the brightness of the LED inside the vehicle;

An air sensor that may detect the air quality inside the vehicle.

Therefore, the bluetooth processing chip of the processing device may also be connected to the LED inside the vehicle, so as to adjust the brightness of the LED according to the brightness information of the brightness sensor.

The bluetooth processing chip may also be connected to an air conditioner inside the vehicle, so as to adjust the temperature or the humidity inside the vehicle according to the humidity sensor or the temperature sensor.

When the bluetooth processing chip is not connected to the electronic device, it may send a broadcast signal (ibeacon frames). When the electronic device is apart from a certain distance from the vehicle, it may receive the broadcast signal, thereby establishing a bluetooth connection with the first connecting control module.

The processing device may further include a power management module connected to each chip, which is used for supplying the power to each module. The processing device may further include a power supply module connected to the power management module, which supplies the power to the electronic device connected to the processing device through the USB interface.

The bluetooth processing chip and the Zigbee integrated chip may be a MCU.

In the embodiment of the disclosure, the processing device may at least include two operation modes, such as sleep mode and work mode,

and when the second connecting control module is not connected to any electronic device or the vehicle is in a stall state, the processing device enters the sleep mode.

Assuming the processing device switches to the work mode from the sleep mode, a possible implement manner may be that, when the first connecting control module establishes the connection with any electronic device, the processing device may be switched to the work state from the sleep mode; another possible implement manner may be that, when the processing device receives a wake-up command, the processing device may be switched to the work state from the sleep mode, wherein the wake-up command may be the processing device achieved by the user through the control device, and the user triggers the corresponding control button of the control device to generate the wake-up command, and transmit the wake-up command to the processing device, so as to trigger the processing device to switch to the work mode from the sleep mode; a still another implement manner may be that, when the processing device starts to supply the power, for example, the supplying voltage changed to non-zero is detected.

Additionally, in the information processing system of the disclosure, the processing device may further communicate with a display module connected to the second connecting control to display the electronic map, the positioning information of the GPS module, the call number and the contact in the call request of the electronic device, etc.

In the disclosure, the information processing system is applied in the vehicle system, it may achieve the detection of the vehicle, and the detected vehicle state information is transmitted to the electronic device, and the audio data of the electronic device is further emitted in the predetermined frequency band to play in the frequency modulation play device of the vehicle system, so as to achieve the vehicle system to play the audio data in the electronic device. It may be applied in the scene of the speech communication and music playing, and may collect the environment sound to transmit to electronic device, thereby achieving the interaction of the electronic device and achieving the speech communication and speech recognition, etc. In the embodiment of the disclosure, the vehicle system and the plurality of detecting devices may be connected through the Zigbee, so as to facilitate the expansion of detecting devices; and the vehicle system may further include the control device, and the control command is send by the control device, and the control command is transmitted to the electronic device through the processing device, so as to achieve the controls of the electronic device, including the selection of the audio data and answering, hanging up and ending the call request, etc. The control device may further achieve the controls of the processing device, including the processing device is triggered to start, the processing device is triggered to transmit the data to the electronic device. According the information processing system of the embodiment of the disclosure, it may enrich the function of the vehicle system, and increase the utilization of vehicle system in the vehicle.

The above description of embodiments, those skilled in the art can clearly understand the various embodiments may be implemented by software plus a necessary universal hardware platform for implementation, and of course, also be implemented by hardware. Based on this understanding, the nature of the technical proposal or the part contributing to the prior art may be embodied in the form of a software product. The computer software product may be stored in a computer readable storage medium, such as ROM/RAM, magnetic disc, CD-ROM, including several instructions to instruct a computer device (a personal computer, a server, or a network equipment) to perform the method described in some parts of the various embodiments or examples.

Finally, it should be noted that the above embodiments are merely provided for describing the technical solutions of the disclosure, but not intended to limit the disclosure. Although reference to the embodiments of the disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the disclosure.

What is claimed is:

1. A information processing system, applied in a vehicle system, the information processing system comprising:
a processing device; and
a plurality of detecting devices which establish a wireless connection with the processing device;
the plurality of detecting devices respectively is disposed on different positions in a vehicle, for detecting a plurality of vehicle state information;
wherein the processing device establishes a wireless connection with an electronic device, for transmitting the vehicle state information detected by the plurality of detecting devices to the electronic device.

2. The information processing system according to claim 1, further comprising a control device disposed in the vehicle and establishes a wireless connection with the processing device;
the processing device receives a control command triggered by the control device, and transmits the control command to the electronic device to trigger the electronic device in response to the control command.

3. The information processing system according to claim 2, wherein the processing device comprises a first connecting control module and a second connecting control module connected each other;
wherein the processing device establishes a wireless connection with the plurality of detecting device through the first connecting control module;
wherein the processing device establishes a wireless connection with the electronic device and the control device through the second connecting control module;
wherein the vehicle state information detected by the plurality of detecting devices are transmitted to the second connecting control module through the first connecting control module, and then are transmitted to the electronic device through the second connecting control module.

4. The information processing system according to claim 3, wherein the processing device further comprises a frequency modulation transmitting module connected to the second connecting control module;
the second connecting control module further obtains an audio data transmitted by the electronic device; the second connecting control module triggers the frequency modulation transmitting module to transmit the audio data transmitted by the electronic device in a predetermined frequency band, such that a frequency modulation play device receives and plays.

5. The information processing system according to claim 3, wherein the processing device further comprises a voice collecting module, for collecting an environment sound;
the second connecting control module further transmits the environment sound collected by the voice collecting module to the electronic device.

6. The information processing system according to claim 5, wherein the processing device further comprises a voice processing module connected to the second connecting control module, for performing a noise reduction process for the environment sound collected by the voice collecting module;
the second connecting control device transmits the environment sound collected by the voice collecting module to the electronic device, wherein the environment sound is performed by the noise reduction process through the voice processing module.

7. The information processing system according to claim 3, wherein the processing device further comprises a storage module, for at least storing the vehicle state information detected by the plurality of detecting devices;
after the second connecting control device is connected to the electronic device, the second connecting control device further synchronously transmits the vehicle state information stored by the storage device to the electronic device.

8. The information processing system according to claim 3, wherein the first connecting control device is a Zigbee integrated chip, and the plurality of detecting device establishes a Zigbee connection with the Zigbee integrated chip;
the second connecting control device is a bluetooth processing chip, for emitting a bluetooth broadcast, such that after the electronic device receives the bluetooth broadcast, the electronic device establishes a connection with the bluetooth processing chip.

9. The information processing system according to claim 3, wherein processing device further comprises a power module connected to the first connecting control device and the second connecting control device, for providing a power to the first connecting control device and the second connecting control device; and
a power supply module connected to the power module, for supplying a power to a device connected to the power supply module.

10. The information processing system according to claim 3, wherein the processing device further comprises a global positioning system connected to the first connecting control unit.

11. The information processing system according to claim 1, wherein the processing device comprises a first connecting control module and a second connecting control module connected each other;
wherein the processing device establishes a wireless connection with the plurality of detecting device through the first connecting control module;
wherein the processing device establishes a wireless connection with the electronic device and the control device through the second connecting control module;
wherein the vehicle state information detected by the plurality of detecting devices are transmitted to the second connecting control module through the first connecting control module, and then are transmitted to the electronic device through the second connecting control module.
